(19) United States
(12) Patent Application Publication
(10) Pub. No.: US 2007/0223826 A1
(43) Pub. Date: Sep. 27, 2007

(54) FINE GRAINED SCALABILITY ORDERING FOR SCALABLE VIDEO CODING

(75) Inventors: Justin Ridge, Sachse, TX (US); Xianglin Wang, Irving, TX (US); Antti Hallapuro, Tampere (FI); Marta Karczewicz, Irving, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/689,444

(22) Filed: Mar. 21, 2007

Related U.S. Application Data
(60) Provisional application No. 60/785,763, filed on Mar. 21, 2006.

(51) Int. Cl. G06K 9/46

(52) U.S. Cl. 382/240

(57) ABSTRACT

Methods, devices, and computer code products for encoding and decoding a video signal involving encoding blocks of the video signal by scan position within a coding cycle in decreasing order to increase the probability that the next symbol will be non-zero. Scalable video decoding techniques can include setting a state variable for a block to a run length if the state variable for the current block is zero otherwise decrementing the state variable if it is not zero. The current coefficient for the block can be set to the terminating value if the state variable is zero otherwise the coefficient can be set to zero if the state variable is not zero.

### FIELD OF THE INVENTION

The present invention relates generally to the field of video coding. More specifically, the present invention relates to scalable video coding and decoding systems and methods.

### BACKGROUND INFORMATION

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Conventional video coding standards (e.g. MPEG-1, H.261/263/264) encode video either at a given quality setting (so-called “fixed QP encoding”) or at a relatively constant bit rate via use of a rate control mechanism. If, for some reason, the video needs to be transmitted or decoded at a different quality, the data must first be decoded then re-encoded using the appropriate setting. In some scenarios, such “transcoding” may not be feasible, for example low-delay real-time applications.

Scalable video coding overcomes this problem by encoding a “base layer” with some minimal quality, then encoding enhancement information that increases the quality up to some maximum level. In addition to selecting between the “base” and “maximum” qualities through inclusion or exclusion of the enhancement information, the enhancement information may be truncated at discrete points, permitting intermediate qualities between the “base” and “maximum”. In cases where the discrete truncation points are closely-spaced, the scalability is said to be “fine-grained”, hence the term “fine grained scalability” (FGS).

Within an enhancement layer, all information is not “equally useful.” For example, values of “zero” do not change the base layer reconstruction, and therefore contribute no valuable information. Consequently, it can be desirable to structure the FGS bit stream such that the “most valuable” information (roughly equivalent to the symbols with greatest non-zero probability) appear first, so that this valuable information is not lost when/if the enhancement layer is truncated.

One method of providing FGS encoding and decoding involves using a “cyclical block coding” procedure. Using this method, the significance pass of the FGS decoding process involves a number of decoding “cycles”. In each cycle, a run of zeros followed by a terminating value is decoded from each block. Consider an example involving four blocks of eight coefficients each:

Block 0={0, 0, 0, 0, 0, 1, 0, 1}

Block 1={0, 1, 0, 1, 0, 0, 0, 0}

Block 2={1, 1, 1, 1, 0, 0, 0, 0}

Block 3={0, 0, 0, 1, 1, 0, 0, 0}

The coefficients of each block can be separated into runs:

Block 0={0, 0, 0, 0, 0, 1} {0, 1}

Block 1={0, 1} {0, 1} {EOB}

Block 2={1} {1} {1} {1} {EOB}

Block 3={0, 0, 0, 1} {1} {EOB}

Where the symbol ‘EOB’ indicates no non-zero coefficients remain.

According to the cyclical block coding method, the first run is decoded from each block, then the second run from each block, and so on. Continuing the example:

Cycle 0=0:{0, 0, 0, 0, 0, 1} 1:{0, 1} 2:{1} 3:{0, 0, 0, 1}

Cycle 1=0:{0, 1} 1:{0, 1} 2:{1} 3:{1}

Cycle 3=1:{EOB} 2:{1} 3:{EOB}

Cycle 4=2:{1}

Cycle 5=2:{1}

Cycle 6=2:{EOB}

Where the number before the colon indicates the block number to which the decoded run belongs.

Using this approach a non-zero value from each block is decoded in each cycle. Since zero values do not result in an enhancement of the base layer quality, this means each cycle improves the quality of at least one coefficient in each block of the frame resulting in improved coding efficiency in the event that the enhancement layer is truncated. Also, using a cyclical approach enhances blocks throughout the frame at the same rate. By contrast, in a strictly block-by-block approach (in which all values from Block 0 are decoded before any values from Blocks 1, 2 or 3), truncating the enhancement layer may result in the first blocks having better quality than later blocks.

However, one of the problems with this approach is that each block will need to be swapped into near (or “fast”) memory once per run if memory is constrained. For example, using the example described above, the number of runs in each block is 2, 3, 5 and 3, respectively. In a memory-constrained environment, 13 swaps are needed, resulting in an average of 3.25 swaps for each coefficient. This high number of swaps could cause an implementation bottleneck. As such, it is desirable to decrease the number of memory swaps in memory constrained systems.

### SUMMARY OF THE INVENTION

One embodiment of the invention relates to scalable video coding techniques involving coding blocks ordered within a coding cycle by scan position to increase the probability that the next symbol will be non-zero. Another embodiment relates to scalable video coding techniques in which processing of a coding cycle only codes those blocks with scan position in a set of “coded scan positions” for the coding cycle, with the remaining blocks omitted from the coding cycle.

Another embodiment of the invention relates to scalable video coding techniques in which a state variable for a block indicates a remaining run length or terminating value of the state variable for the current block. In this embodiment, if the state variable is greater than a minimum value, a coefficient is set to zero and the state variable is decremented. If the state variable is equal to a minimum value, a new value of the state variable is decoded from the bit stream.

In another embodiment, decoding a value of the state variable that belongs to a set of possible “end of block” symbols indicates that all remaining coefficients in the block are set to zero, and the state variable is not modified on subsequent coding cycles.

In a further embodiment, coefficients are rearranged from blocks into subbands prior to encoding, or from subbands into blocks after decoding.

In another embodiment of the invention, it is possible to process “n” subbands per cycle to improve memory swapping. In some implementations having a large number of blocks, it is further possible to process all subbands within a group of blocks before moving on to the next group of blocks to reduce memory swapping. In still another embodiment, a two-dimensional groups may be formed by grouping in subband dimension and grouping in block dimension.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the an exemplary embodiment.

### BRIEF DESCRIPTION OF THE DRAWINGS

FIG. 1 is a perspective view of a communication device that can be used in an exemplary embodiment.

FIG. 2 is a block diagram illustrating an exemplary functional embodiment of the communication device of FIG. 1.

FIG. 3 is an illustration of one method for scalable video decoding in accordance with the present invention.

### DETAILED DESCRIPTION OF THE PREFERRED EMBODIMENTS

Exemplary embodiments present methods, computer code products, and devices for efficient enhancement layer encoding and decoding. Embodiments can be used to solve some of the problems inherent to existing solutions. For example, these embodiments can be used to improve the overall coding efficiency of a scalable coding scheme.

As used herein, the term “enhancement layer” refers to a layer that is coded differentially compared to some lower quality reconstruction. The purpose of the enhancement layer is that, when added to the lower quality reconstruction, signal quality should improve, or be “enhanced.” Further, the term “base layer” applies to both a non-scalable base layer encoded using an existing video coding algorithm, and to a reconstructed enhancement layer relative to which a subsequent enhancement layer is coded.

As noted above, embodiments include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions. Any common programming language, such as C or C++, or assembly language, can be used to implement the invention.

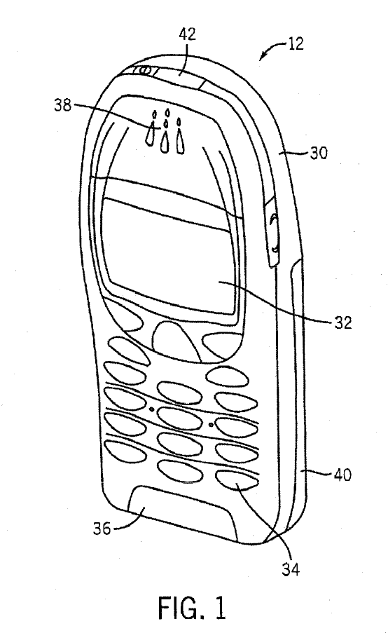

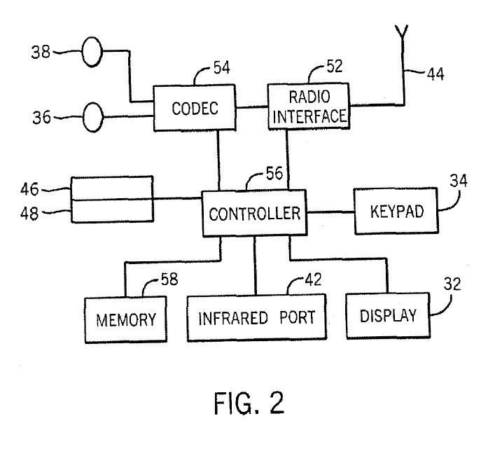

FIGS. 1 and 2 show an example implementation as part of a communication device (such as a mobile communication device like a cellular telephone, or a network device like a base station, router, repeater, etc.). However, it is important to note that the present invention is not limited to any type of electronic device and could be incorporated into devices such as personal digital assistants, personal computers, mobile telephones, and other devices. It should be understood that the present invention could be incorporated on a wide variety of devices.

The device 12 of FIGS. 1 and 2 includes a housing 30, a display 32, a keypad 34, a microphone 36, an ear-piece 38, a battery 40, radio interface circuitry 52, codec circuitry 54, a controller 56 and a memory 58. Individual circuits and elements are all of a type well known in the art, for example in the Nokia range of mobile telephones. The exact architecture of device 12 is not important. Different and additional components of device 12 may be incorporated into the device 12. The scalable video encoding and decoding techniques of the present invention could be performed in the codec circuitry 54, controller 56, and memory 58 of the device 12.

The exemplary embodiments are described in the general context of method steps or operations, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations could be accomplished with standard programming techniques, with rule based logic, and/or other logic to accomplish the various database searching steps, correlation steps, comparison steps and decision steps. It should also be noted that the words “module” as used herein and in the claims is intended to encompass implementations using one or more lines of software code, and/or hardware implementations, and/or equipment for receiving manual inputs.

Some scalable video coding techniques can include ordering blocks within a coding cycle such that blocks scan positions for which the probability of the next symbol being nonzero is higher are coded before blocks in which the probability of the next symbol being nonzero is lower. The probability of the next coefficient being non-zero can be described as a function of the current scan position, written as P(s) where ‘s’ is the scan index. According to this invention, it is possible to order blocks so that blocks with scan position ‘a’ are coded before blocks with scan position ‘b’ within a coding cycle if P(a)>P(b). In the specific case where P(a)>P(b) for a<b, which is generally true for most enhancement information, blocks with a lower scan position can be processed before blocks with a higher scan position.

In one embodiment of the present invention, only those blocks with a scan position belonging to a set of “coded scan positions” are coded in a given coding cycle. The set of “coded scan positions” may vary from one cycle to another. The set of “coded scan positions” may be specified in the bit stream, may be fixed at both encoder and decoder, or may take the form of a mathematical function. For example, one mathematical function would involve a scan position threshold so that, in a given coding cycle, only blocks with a scan position below the threshold are coded.

In one embodiment, the set of “coded scar positions” contains one value, equal to the cycle number. In the case where P(a)>P(b) for a<b, this is equivalent to only coding the lowest uncoded scan position in each cycle, then terminating the coding cycle.

Applying the example discussed above to a coding technique involving coding blocks by scan position:

Block 0={0, 0, 0, 0, 0, 1, 0, 1}

Block 1={0, 1, 0, 1, 0, 0, 0, 0}

Block 2={1, 1, 1, 1, 0, 0, 0, 0}

Block 3={0, 0, 0, 1, 1, 0, 0, 0}

The first cycle would proceed unmodified:

Cycle 0=0:{0, 0, 0, 0, 0, 1} 1:{0, 1} 2:{1} 3:{0, 0, 0, 1}

At the start of the second cycle, the scan positions would be 6, 2, 1 and 4, respectively. In this example, the minimum scan position is 1, so only blocks with scan position 1 would be decoded in the second cycle:

Cycle 1=2:{1}

At the start of the third cycle, the scan positions would be 6, 2, 2 and 4, respectively. Using this example, only blocks with scan position 2 would be decoded in the third cycle:

Cycle2=1:{0, 1} 2:{1}

At the start of the fourth cycle, the scan positions would be 6, 4, 3 and 4, respectively. Continuing this example, only blocks with scan position 3 would be decoded in the fourth cycle:

Cycle 3=2:{1}

At the start of the fifth cycle, the scan positions would be 6, 4, 4 and 4, respectively. Following the example, only blocks with scan position 4 would be decoded in the fifth cycle, and so on:

Cycle 4=1:{EOB} 2:{EOB} 3:{1}

Cycle 5=3:{EOB}

Cycle 6=1:{0, 1}

In one embodiment of the invention, memory swapping can be reduced by arranging coefficient information into subbands, which can then be processed one at a time. For example, the first coefficient from each block can form the first subband, and so on:

Subband 0={0, 0, 1, 0}

Subband 1={0, 1, 1, 0}

Subband 2={0, 0, 1, 0}

Subband 3={0, 1, 1, 1}

Subband 4={0, 0, 0, 1}

Subband 5={1, 0, 0, 0}

Subband 6={0, 0, 0, 0}

Subband 7={1, 0, 0, 0}

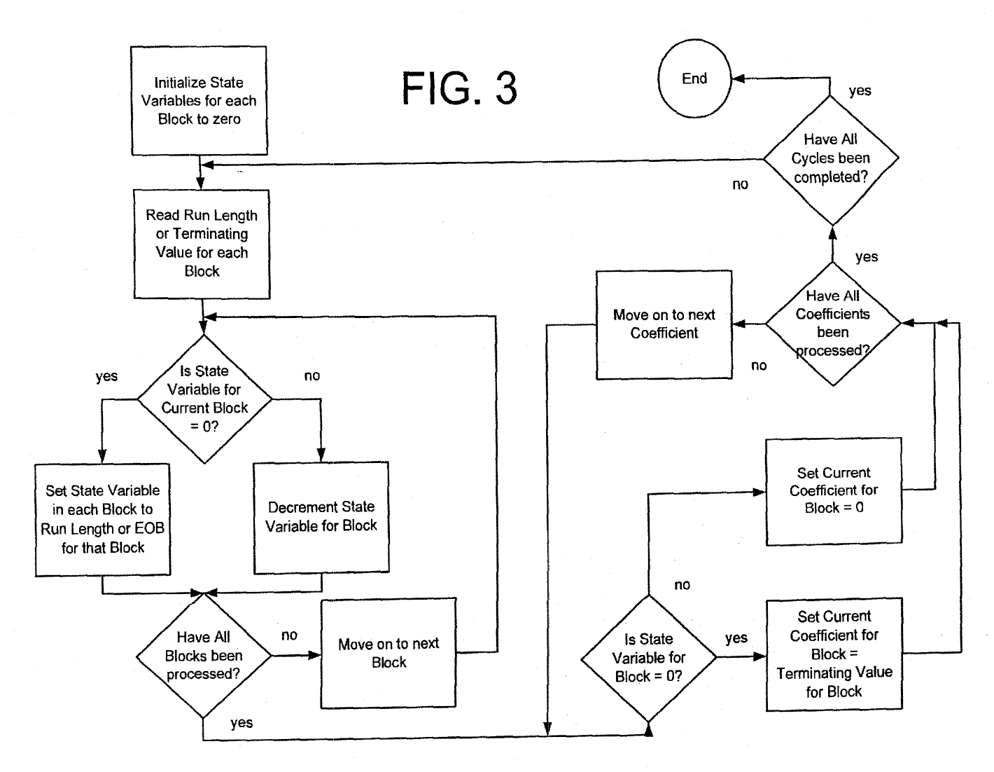

In this decoding process (which is illustrated in FIG. 3), a state variable (initialized to zero) can exist for each block. For each block in each subband, the following process can be used:

The state variables are set as follows:
If the state variable for the current block is equal to zero, a run length can be read from the bit stream and the state variable can be set equal to this value. A terminating value can also be read from the bit stream and stored in a second state variable for the block.
Otherwise, the state variable can be decremented if it is non-zero.

The current coefficients can be set as follows:
If the state variable is equal to zero, the current coefficient can be set equal to the terminating value.
If the state variable is not zero, the current coefficient can be set equal to zero.

Following this approach, In cycle 0, the state variables can be initialized to [0 0 0 0]; run length values of 5, 1, 0, 3 can be read and the state variables can be reset to [5 1 0 3]. Continuing this example, the subband values can be set according to whether or not state variables are non-zero, which in this case would be: Subband 0={0, 0, 1, 0}

Continuing on with cycle 1: with state variables of [5 1 0 3]; a run length value of 0 would be read for Block 2 and the state variables for Blocks 0, 1, and 3 would be decremented such that the state variables become: [4 0 0 2]. The subband values can be set according to whether or not state variables are non-zero making subband 1={0, 1, 1, 0}

Cycle 2 can continue with run length values of 1, 0 being read for Blocks 1 and 2, respectively. Following this example the state variables for Blocks 1 and 2 would be set to 1 and 0 respectively and the state variables for Blocks 0 and 3 would be decremented resetting the set variables to: [3 1 0 1]. Next, the subband values can be set according to whether or not state variables are non-zero making subband 2={0, 0, 1, 0}

Applying the example to cycle 3: a run length value of 0 would be read for Block 2 so the state variable for Block 2 would be set to 0. The state variable for Blocks 0, 1, and 3 would be decremented resetting the state variable to: [2 0 0 0]. The subband values can be set according to whether or not state variables are non-zero making subband 3={0, 1, 1, 1}

Cycle 4 would continue with terminating values of EOB, and EOB being read for Blocks 1 and 2 and run length value 0 being read for Block 3. Thus the state variable for Blocks 1, 2, and 3 would be set to EOB, EOB, and 0, respectively and the other state variable for Block 0 would be decremented making the state variables=[1 E E 0], where ‘E’ is an abbreviation for EOB. The subband values could be set according to whether or not state variables are non-zero making subband 4={0, 0, 0, 1}

Cycle 5 would start with state variables [1 E E 0]. A terminating value of EOB would be read for Block 3. Accordingly, the state variable for Block 3 would be set to EOB and the state variable for Block 0 would be decremented making the state variables=[0 E E E]. Again, the subband values would be set according to whether or not state variables are non-zero making subband 5={1, 0, 0, 0}

Cycle 6 would start with state variables [0 E E E]. A run length value of 1 would be read for Block 0 making the new state variables=[1 E E E]. The subband values would be set according to whether or not state variables are non-zero making subband 6={0, 0, 0, 0}

Cycle 7 would start with state variables [1 E E E]. No run values would be read because none of the state variables=0. Instead, the state variable for Block 0 would be decremented making the state variables=[0 E E E]. The subband values would be set according to whether or not state variables are non-zero making subband 7={1, 0, 0}

Pseudo-code for this method can be written as follows:

for each subband {

for each coeff index {

if (block_counter == 0)

read new block_counter and terminating value

for block

else

--block_counter

if (block_counter == 0)

set subband coeff to terminating value for

block

else

set subband coeff to zero

}

}

In a further embodiment, the terminating value may be decoupled from the run value, and read directly into the subband when it is needed, instead of into a temporary value. This could further reduce temporary memory requirements.

Note that when decoding the run, various binary representations indicating the run length are possible, as this embodiment is not dependant upon the precise entropy coding mechanism. In CABAC, the individual significance flags may be decoded instead of the run length, e.g. 0 0 0 1 instead of the digit ‘3’. In CAVLC, the use of features such as “EOB offset” symbols, as already done in H.264/AVC Annex F, remains possible according to embodiments of the invention.

Using this embodiment of the invention, each coefficient is swapped into memory only once as opposed to the 3.25 swaps per coefficient discussed above. This embodiment may require re-arranging the coefficients from subbands back into block after decoding, but for cache-based processors this can usually be implemented using fast operations.

In another embodiment of the invention, it is possible to process ‘n’ subbands per cycle to improve memory swapping. The number of subbands ‘n’ may be constant per cycle, or may vary from one cycle to another. For example, since most energy is concentrated in low subbands, it may be expedient to use n=1 for the first two or three cycles, then n>1 for subsequent cycles.

The exact number of subbands in each cycle may be hard-coded (e.g. determined by some statistical training), or may be signaled in the bit stream. The number of subbands coded in one cycle may also be determined based on previously decoded information, for example information decoded in previous cycle(s). One example of pseudo-code for an embodiment of this invention could be:

for each subband group {

for each coeff index {

for each subband within subband group {

if (block_counter == 0)

read new block_counter and terminating value

for block

else

--block_counter

if (block_counter == 0)

set subband coeff to terminating value for

block

else

set subband coeff to zero

}

}

}

In some implementations of FGS coding, every block can be processed in each subband. For frames with large numbers of blocks, it may not be possible to load the entire subband into “fast” memory. Thus, in one embodiment of the invention it may be desirable to process all subbands within a group of blocks, then move to the next group of blocks to reduce memory swapping. One example of pseudo-code for implementing this aspect may be:

for each group of blocks {

for each subband {

for each coeff index {

if (block_counter == 0)

read new block_counter and terminating value

for block

else

--block_counter

if (block_counter == 0)

set subband coeff to terminating value for

block

else

set subband coeff to zero

}

}

}

The number of blocks ‘m’ in a group of blocks can be related to the amount of “fast memory” available on target platforms. This can be hard-coded, signaled in the bit stream, or determined dynamically based on previously decoded information. Furthermore, it is possible to form two-dimensional ‘m x n’ groups by grouping in the subband dimension and grouping in the block dimension.

In some implementations, the ordering process may be intended for use in the “significance pass” of FGS decoding, although the concept could equally be applied to other applications. In an actual system, all coefficient values may not be assigned to the significance pass. Some may be assigned to the refinement pass. In one embodiment of the invention the significance and refinement information can be interleaved.

The significance and refinement passes may be distinct, so that all significance information for the frame is decoded before any refinement information. The significance and refinement information can be separated by subband, so that decoding an entire subband of significance coefficients (or group of subbands), can be followed by an equivalent subband of refinement coefficients. The significance and refinement values may be completely interleaved.

Denoting refinement values in an 8-coefficient block using letters of the alphabet and significance values by digits, two example blocks might be: 0 0 A 0 1 B 1 0, and 1 C D E 1 0 0 F. In the above example methods, the respective order of decoding could be:

{0 0 0 1} {1} {1} {1} {EOB} {EOB} then {C} {AD} {E} {B} {F}

{0 0 0 1} {1} {C} {A D} {E} {1} {EOB} {B} {1} {EOB} {F}

{0 0 0 1} {1} {C} {A D} {E} {1} {B} {EOB} {1} {EOB} {F}

Although, other interleaving methods that involve variations on the above themes are also possible.

When variable-length codes (VLC) are utilized for entropy coding of FGS information, grouping refinement bits is useful in producing shorter codewords and consequently improving coding efficiency. In the current version of H.264/AVC Annex F, there is no interleaving, but rather all refinement bits are coded in a single cycle when VLCs are used.

According to various embodiments of the invention, grouping of refinement bits may take place by subband. In the examples above, note that refinement bits ‘A’ and ‘D’, which both correspond to the third subband, are grouped as {A D} to yield a single VLC codeword. In one embodiment, the VLC “buffer” is flushed of partial codewords at the end of a slice. In a further embodiment, it is flushed once per subband. In still another embodiment, it is flushed periodically, e.g. every ‘k’ coefficients, or every ‘j’ refinement coefficients. Other periodic flushing schemes are also possible following the same principle.

According to embodiments of the invention, grouping of refinement bits may take place by block. When grouping by block, a “look ahead” or “look back” method may be used. Considering the third example above:

{0 0 0 1} {1} {C} {A D} {E} {1} {B} {EOB} {1} {EOB} {F}

When grouping refinement coefficients by block, ‘A’ and ‘B’ would be grouped to form a single VLC codeword. In this case, the “look ahead” method would involve coding both A and B in the cycle of the first coefficient, A:

{0 0 0 1} {1} {CD} {AB} {EF} {1} {EOB} {1} {EOB}

In the “look back” method, the coding of both A and B occurs in the cycle of the last coefficient, B:

{0 0 0 1} {1} {CD} {1} {AB} {EOB} {1} {EOB} {EF}

The number of refinement coefficients grouped to form a single VLC codeword is not necessarily fixed at two, and may be determined dynamically according to an existing entropy coding method.

Currently, refinement coefficients are grouped at the end of a block when using VLCs in H.264/AVC Annex F. According to embodiments of the invention, the method of H.264/AVC Annex F may be improved by processing complete codewords in a cyclical fashion. For example, if the refinement bits for three blocks are:

A, B, C, D
E, F
G, H, I

Then the current H.264/AVC Annex F would code the refinement bits in the precise order shown above, i.e. A, B, C, D, E, F, G, H, I. If the grouping size is two, a possible alternative would be {A B}, {E F}, {G H}, {C D}, {I}. This has the benefit of distributing the refinement more evenly within a slice. Various schemes for interleaving significance and refinement values, including but not limited to those disclosed above, may be applied. It is also possible to code all significance values in a block before all refinement values. In this case, refinement bits may be start to be coded in different cycles for each block, but the since the significance coefficients are coded first, the exact cycle may be later than in the aforementioned interleaving schemes. The interleaving example in this case would become:{0 0 0 1} {1} {1} {1} {EOB} {EOB} {AB} {CD} {EF}.

While several embodiments of the invention have been described, it is to be understood that modifications and changes will occur to those skilled in the art to which the invention pertains. Accordingly, the claims appended to this specification are intended to define the invention precisely.

What is claimed is:

1. A method for decoding an encoded scalable video signal in groups of subbands, the scalable video signal including blocks, each subband comprising coefficients from each block, the method comprising:
for each decoding group of subbands;
for each decoding block;
checking whether or not all the coefficients in the decoded group of subbands in the decoded block have been decoded, and when it is determined that any coefficients have not been decoded:
reading a run length from the encoded video signal;
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

2. The method of claim 1, the method further comprises:
determining the decoded subband, corresponding to the lowest coefficient index in the decoded group of subbands in the decoded block, for which the coefficient has yet to be decoded.

3. The method of claim 1, the method further comprises:
setting the coefficients in the decoding block equal to zero, starting at the decoding subband and ending before the decoding subband with the coefficient index.

4. The method of claim 1, the method further comprises:
marking the coefficients in the decoding block as being coded, starting at the decoding subband and ending before the subband corresponding to the coefficient index.

5. The method of claim 1, the method further comprises:
initializing a coded indicator to each coefficient in each block, the coded indicator indicative of whether or not the coefficient has been decoded;
marking the coded indicators corresponding to the decoded block and coefficients which start at the decoded subband and ending at the subband with the coefficient index to a value representing that the coefficients have been decoded; and
wherein the checking step is performed by examining the coded indicator of coefficients of the decoded block.

6. The method of claim 1, the method further comprising:
setting a state variable for each block, the state variable corresponding to the lowest coefficient index in the block for which a coefficient is yet to be decoded;
resetting the state variable based upon the run length;
wherein the checking step involves determining whether the state variable is equal to a fixed number, and decrementing the state variable if it is not.

7. The method of claim 1, wherein the number of subbands processed in a given group of subbands is determined by statistical training.

8. The method of claim 1, wherein the number of subbands processed in a given group of subbands is signaled in the video signal.

9. The method of claim 1, wherein the number of subbands processed in a given group of subbands is determined by information decoded from a previous decoding cycle.

10. The method of claim 1, wherein all coefficients for each subband are processed before processing coefficients for the next subband.

11. The method of claim 1, wherein the video signal further comprises significance information and refinement information.

12. The method of claim 11, wherein all significance information for a frame of the video signal is decoded before any refinement information for the frame is decoded.

13. The method of claim 11, wherein the significance information and refinement information is separated by subband and wherein decoding of a subband of significance information is followed by decoding of the corresponding subband of refinement information.

14. The method of claim 11, wherein the significance information and refinement information are interleaved.

15. The method of claim 14, wherein the run length includes both significant and refinement coefficients.

16. The method of claim 14, wherein the run length includes only significant coefficients.

17. A method for decoding an encoded scalable video signal in groups of subbands, the scalable video signal including blocks, each subband comprising coefficients from each block, the method comprising:
for each decoding group of subbands;
for each decoding block;
checking whether or not all the coefficients in the decoded group of subbands in the decoded block have been decoded, and when it is determined that any coefficients have not been decoded:
determining wheather or not the coefficient corresponding to the decoded subband in the decoded block is a refinement coefficient;
if the coefficient is a refinement coefficient:
retrieving a refinement value from the encoded video signal;
if the coefficient is not a refinement coefficient:
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

18. The method of claim 17, the method further comprises:
determining the decoded subband, corresponding to the lowest coefficient index in the decoded group of subbands in the decoded block, for which the coefficient has yet to be decoded.

19. The method of claim 17, the method further comprises:
setting the coefficients in the decoding block equal to zero, starting at the decoding subband and ending before the subband corresponding to the coefficient index, excluding refinement coefficients.

20. The method of claim 17, the method further comprises:
if a refinement coefficient has been retrieved, marking the refinement coefficient in the decoded block as being coded;
otherwise, marking the coefficients in the decoding block as being coded, starting at the decoding subband and ending before the decoding subband with the coefficient index, excluding refinement coefficients.

21. The method of claim 17, the method further comprises:
initializing a coded indicator to each coefficient in each block, the coded indicator indicative of whether or not the coefficient has been decoded;
if a refinement coefficient has been retrieved, marking the coded indicator corresponding to the decoded block and refinement coefficient to a value representing that the coefficient has been decoded;
otherwise, marking the coded indicators corresponding to the decoded block and coefficients which start at the decoded subband and ending at the subband with the coefficient index, excluding refinement coefficients, to a value representing that the coefficients have been decoded;
wherein the checking step is performed by examining the coded indicator of coefficients of the decoded block.

22. The method of claim 17, the method further comprising:
setting a state variable for each block, the state variable corresponding to the lowest coefficient index in the block for which a non-refinement coefficient is yet to be decoded;
resetting the state variable based upon the run length;
wherein the checking step involves determining whether the state variable is equal to a fixed number and the coefficient is not a refinement coefficient, and decrementing the state variable if it is not.

23. The method of claim 17, wherein the identification of the coefficient index involves skipping the refinement coefficients.

24. The method of claim 1, the method further comprises:
retrieving the coefficient value from the encoded video signal.

25. The method of claim 17, the method further comprises:
retrieving the coefficient value from the encoded video signal.

26. The method of claim 1, the method further comprises:
determining the coefficient value based on a value retrieved from the encoded video signal.

27. The method of claim 17, the method further comprises:
determining the coefficient value based on a value retrieved from the encoded video signal.

28. The method of claim 1, wherein the coefficient value has a pre-determined magnitude and the method further comprises:
retrieving a sign information from the encoded video signal.

29. The method of claim 17, wherein the coefficient value has a pre-determined magnitude and the method further comprises:
retrieving a sign information from the encoded video signal.

30. The method of claim 1, after reading the last run length in the decoded block, the method further comprises:
retrieving a terminating value from the encoded video signal; and
adjusting the coefficient values in the decoded block based upon the terminating value.

31. The method of claim 17, after reading the last run length in the decoded block, the method further comprises:
retrieving a terminating value from the encoded video signal; and
adjusting the coefficient values in the decoded block based upon the terminating value.

32. An apparatus for decoding an encoded scalable video signal in groups of subbands, the scalable video signal including blocks, each subband comprising coefficients from each block, the apparatus comprising:
a processor;
memory effectively coupled to the process; and
computer code stored in memory and executable by the processor, the computer code comprising instructions for decoding subbands by:
for each decoding group of subbands;
for each decoding block;
checking whether or not all the coefficients in the decoded group of subbands in the decoded block have been decoded, and when it is determined that any coefficients have not been decoded:
reading a run length from the encoded video signal;
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

33. The apparatus of claim 32, wherein the computer code further comprises instructions for:
determining the decoded subband, corresponding to the lowest coefficient index in the decoded group of subbands in the decoded block, for which the coefficient has yet to be decoded.

34. The apparatus of claim 32, wherein the computer code further comprises instructions for:
setting the coefficients in the decoding block equal to zero, starting at the decoding subband and ending before the decoding subband with the coefficient index.

35. The apparatus of claim 32, wherein the computer code further comprises instructions for:
marking the coefficients in the decoding block as being coded, starting at the decoding subband and ending before the subband corresponding to the coefficient index.

36. The apparatus of claim 32, wherein the computer code further comprises instructions for:
initializing a coded indicator to each coefficient in each block, the coded indicator indicative of whether or not the coefficient has been decoded;
marking the coded indicators corresponding to the decoded block and coefficients which start at the decoded subband and ending at the subband with the coefficient index to a value representing that the coefficients have been decoded; and
wherein the checking step is performed by examining the coded indicator of coefficients of the decoded block.

37. The apparatus of claim 32, wherein the computer code further comprises instructions for:
setting a state variable for each block, the state variable corresponding to the lowest coefficient index in the block for which a coefficient is yet to be decoded;
resetting the state variable based upon the run length;
wherein the checking step involves determining whether the state variable is equal to a fixed number, and decrementing the state variable if it is not.

38. The apparatus of claim 32, wherein the number of subbands processed in a given group of subbands is determined by statistical training.

39. The apparatus of claim 32, wherein the number of subbands processed in a given group of subbands is signaled in the video signal.

40. The apparatus of claim 32, wherein the number of subbands processed in a given group of subbands is determined by information decoded from a previous decoding cycle.

41. The apparatus of claim 32, wherein all coefficients for each subband are processed before processing coefficients for the next subband.

42. The apparatus of claim 32, wherein the video signal further comprises significance information and refinement information.

43. The apparatus of claim 42, wherein all significance information for a frame of the video signal is decoded before any refinement information for the frame is decoded.

44. The apparatus of claim 42, wherein the significance information and refinement information is separated by subband and wherein decoding of a subband of significance information is followed by decoding of the corresponding subband of refinement information.

45. The apparatus of claim 42, wherein the significance information and refinement information are interleaved.

46. The apparatus of claim 45, wherein the run length includes both significant and refinement coefficients.

47. The apparatus of claim 45, wherein the run length includes only significant coefficients.

48. An apparatus for decoding an encoded scalable video signal in groups of subbands, the scalable video signal including blocks, each subband comprising coefficients from each block, the apparatus comprising:
a processor;
memory effectively coupled to the process; and
computer code stored in memory and executable by the processor, the computer code comprising instructions for decoding subbands by:
for each decoding group of subbands;
for each decoding block;
checking whether or not all the coefficients in the decoded group of subbands in the decoded block have been decoded, and when it is determined that any coefficients have not been decoded:
determining wheather or not the coefficient corresponding to the decoded subband in the decoded block is a refinement coefficient;
if the coefficient is a refinement coefficient:
retrieving a refinement value from the encoded video signal;
if the coefficient is not a refinement coefficient:
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

49. The apparatus of claim 48, wherein the computer code further comprises instructions for:
determining the decoded subband, corresponding to the lowest coefficient index in the decoded group of subbands in the decoded block, for which the coefficient has yet to be decoded.

50. The apparatus of claim 48, wherein the computer code further comprises instructions for:
setting the coefficients in the decoding block equal to zero, starting at the decoding subband and ending before the subband corresponding to the coefficient index, excluding refinement coefficients.

51. The apparatus of claim 48, wherein the computer code further comprises instructions for:
if a refinement coefficient has been retrieved, marking the refinement coefficient in the decoded block as being coded;
otherwise, marking the coefficients in the decoding block as being coded, starting at the decoding subband and ending before the decoding subband with the coefficient index, excluding refinement coefficients.

52. The apparatus of claim 48, wherein the computer code further comprises instructions for:
initializing a coded indicator to each coefficient in each block, the coded indicator indicative of whether or not the coefficient has been decoded;
if a refinement coefficient has been retrieved, marking the coded indicator corresponding to the decoded block and refinement coefficient to a value representing that the coefficient has been decoded;
otherwise, marking the coded indicators corresponding to the decoded block and coefficients which start at the decoded subband and ending at the subband with the coefficient index, excluding refinement coefficients, to a value representing that the coefficients have been decoded;
wherein the checking step is performed by examining the coded indicator of coefficients of the decoded block.

53. The apparatus of claim 48, wherein the computer code further comprises instructions for:
setting a state variable for each block, the state variable corresponding to the lowest coefficient index in the block for which a non-refinement coefficient is yet to be decoded;
resetting the state variable based upon the run length;
wherein the checking step involves determining whether the state variable is equal to a fixed number and the coefficient is not a refinement coefficient, and decrementing the state variable if it is not.

54. The apparatus of claim 48, wherein the identification of the coefficient index involves skipping the refinement coefficients.

55. The apparatus of claim 32, wherein the computer code further comprises instructions for:
retrieving the coefficient value from the encoded video signal.

56. The apparatus of claim 48, wherein the computer code further comprises instructions for:
retrieving the coefficient value from the encoded video signal.

57. The apparatus of claim 32, wherein the computer code further comprises instructions for:
determining the coefficient value based on a value retrieved from the encoded video signal.

58. The apparatus of claim 48, wherein the computer code further comprises instructions for:
determining the coefficient value based on a value retrieved from the encoded video signal.

59. The apparatus of claim 32, wherein the coefficient value has a pre-determined magnitude and the computer code farther comprises instructions for:
retrieving a sign information from the encoded video signal.

60. The apparatus of claim 48, wherein the coefficient value has a pre-determined magnitude and the computer code further comprises instructions for:
retrieving a sign information from the encoded video signal.

61. The apparatus of claim 32, after reading the last run length in the decoded block, the computer code further comprises instructions for:
retrieving a terminating value from the encoded video signal; and
adjusting the coefficient values in the decoded block based upon the terminating value.

62. The apparatus of claim 48, after reading the last run length in the decoded block, the computer code further comprises instructions for:
retrieving a terminating value from the encoded video signal; and
adjusting the coefficient values in the decoded block based upon the terminating value.

63. A computer software program stored on a computer-readable medium, the software program causing the computer to perform a method for decoding an encoded scalable video signal in groups of subbands, the scalable video signal including blocks, each subband comprising coefficients from each block, the method comprising:
for each decoding group of subbands;
for each decoding block;
checking whether or not all the coefficients in the decoded group of subbands in the decoded block have been decoded, and when it is determined that any coefficients have not been decoded:
reading a run length from the encoded video signal;
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

64. The computer software program of claim 63, wherein the computer program further comprises instructions for:
determining the decoded subband, corresponding to the lowest coefficient index in the decoded group of subbands in the decoded block, for which the coefficient has yet to be decoded.

65. The computer software program of claim 63, wherein the computer program further comprises instructions for:
setting the coefficients in the decoding block equal to zero, starting at the decoding subband and ending before the decoding subband with the coefficient index.

66. The computer software program of claim 63, wherein the computer program further comprises instructions for:
marking the coefficients in the decoding block as being coded, starting at the decoding subband and ending before the subband corresponding to the coefficient index.

67. The computer software program of claim 63, wherein the computer program further comprises instructions for:
initializing a coded indicator to each coefficient in each block, the coded indicator indicative of whether or not the coefficient has been decoded;
marking the coded indicators corresponding to the decoded block and coefficients which start at the decoded subband and ending at the subband with the coefficient index to a value representing that the coefficients have been decoded; and
wherein the checking step is performed by examining the coded indicator of coefficients of the decoded block.

68. The computer software program of claim 63, wherein the computer program further comprises instructions for:
setting a state variable for each block, the state variable corresponding to the lowest coefficient index in the block for which a coefficient is yet to be decoded;
resetting the state variable based upon the run length;
wherein the checking step involves determining whether the state variable is equal to a fixed number, and decrementing the state variable if it is not.

69. The computer software program of claim 63, wherein the number of subbands processed in a given group of subbands is determined by statistical training.

70. The computer software program of claim 63, wherein the number of subbands processed in a given group of subbands is signaled in the video signal.

71. The computer software program of claim 63, wherein the number of subbands processed in a given group of subbands is determined by information decoded from a previous decoding cycle.

72. The computer software program of claim 63, wherein all coefficients for each subband are processed before processing coefficients for the next subband.

73. The computer software program of claim 63, wherein the video signal further comprises significance information and refinement information.

74. The computer software program of claim 73, wherein all significance information for a frame of the video signal is decoded before any refinement information for the frame is decoded.

75. The computer software program of claim 73, wherein the significance information and refinement information is separated by subband and wherein decoding of a subband of significance information is followed by decoding of the corresponding subband of refinement information.

76. The computer software program of claim 73, wherein the significance information and refinement information are interleaved.

77. The computer software program of claim 73, wherein the run length includes both significant and refinement coefficients.

78. The computer software program of claim 73, wherein the run length includes only significant coefficients.

79. A computer software program stored on a computer-readable medium, the software program causing the computer to perform a method for decoding an encoded scalable video signal in groups of subbands, the scalable video signal including blocks, each subband comprising coefficients from each block, the method comprising:
for each decoding group of subbands;
for each decoding block;
checking whether or not all the coefficients in the decoded group of subbands in the decoded block have been decoded, and when it is determined that any coefficients have not been decoded:
determining wheather or not the coefficient corresponding to the decoded subband in the decoded block is a refinement coefficient;
if the coefficient is a refinement coefficient:
retrieving a refinement value from the encoded video signal;
if the coefficient is not a refinement coefficient:
identifying a coefficient index based on a decoded subband in the decoded group of subbands in the decoded block and the run-length;
setting value of the coefficient corresponding to the coefficient index in the decoded block based on a coefficient level;
repeating said checking until all coefficients in the decoded group of subbands in the decoded block have been decoded.

80. The computer software program of claim 79, wherein the computer program further comprises instructions for:
determining the decoded subband, corresponding to the lowest coefficient index in the decoded group of subbands in the decoded block, for which the coefficient has yet to be decoded.

81. The computer software program of claim 79, wherein the computer program further comprises instructions for:
setting the coefficients in the decoding block equal to zero, starting at the decoding subband and ending before the subband corresponding to the coefficient index, excluding refinement coefficients.

82. The computer software program of claim 79, wherein the computer program further comprises instructions for:
if a refinement coefficient has been retrieved, marking the refinement coefficient in the decoded block as being coded;
otherwise, marking the coefficients in the decoding block as being coded, starting at the decoding subband and ending before the decoding subband with the coefficient index, excluding refinement coefficients.

83. The computer software program of claim 79, wherein the computer program further comprises instructions for:
initializing a coded indicator to each coefficient in each block, the coded indicator indicative of whether or not the coefficient has been decoded;
if a refinement coefficient has been retrieved, marking the coded indicator corresponding to the decoded block and refinement coefficient to a value representing that the coefficient has been decoded;
otherwise, marking the coded indicators corresponding to the decoded block and coefficients which start at the decoded subband and ending at the subband with the coefficient index, excluding refinement coefficients, to a value representing that the coefficients have been decoded;
wherein the checking step is performed by examining the coded indicator of coefficients of the decoded block.

84. The computer software program of claim 79, wherein the computer program further comprises instructions for:
setting a state variable for each block, the state variable corresponding to the lowest coefficient index in the block for which a non-refinement coefficient is yet to be decoded;
resetting the state variable based upon the run length;
wherein the checking step involves determining whether the state variable is equal to a fixed number and the coefficient is not a refinement coefficient, and decrementing the state variable if it is not.

85. The computer software program of claim 79, wherein the identification of the coefficient index involves skipping the refinement coefficients.

86. The computer software program of claim 63, wherein the computer program further comprises instructions for:
retrieving the coefficient value from the encoded video signal.

87. The computer software program of claim 79, wherein the computer program further comprises instructions for:
retrieving the coefficient value from the encoded video signal.

88. The computer software program of claim 63, wherein the computer program further comprises instructions for:
determining the coefficient value based on a value retrieved from the encoded video signal.

89. The computer software program of claim 79, wherein the computer program further comprises instructions for:
determining the coefficient value based on a value retrieved from the encoded video signal.

90. The computer software program of claim 63, wherein the coefficient value has a pre-determined magnitude and the method further comprises:
retrieving a sign information from the encoded video signal.

91. The computer software program of claim 79, wherein the coefficient value has a pre-determined magnitude and the method further comprises:
retrieving a sign information from the encoded video signal.

92. The computer software program of claim 63, after reading the last run length in the decoded block, the method further comprises:
retrieving a terminating value from the encoded video signal; and
adjusting the coefficient values in the decoded block based upon the terminating value.

92. The computer software program of claim 79, after reading the last run length in the decoded block, the method further comprises:
retrieving a terminating value from the encoded video signal; and
adjusting the coefficient values in the decoded block based upon the terminating value.
